(19) United States
(12) Patent Application Publication
(10) Pub. No.: US 2025/0296282 A1
(43) Pub. Date: Sep. 25, 2025

(54) EXTRUSION DEVICE AND 3D PRINTER

(71) Applicants: UNIVERSITA' DELLA CALABRIA, Rende (CS) (IT); OPTIDE S.R.L., Rende (CS) (IT)

(72) Inventors: Giuseppe SERRATORE, Filadelfia (VV) (IT); Francesco GAGLIARDI, Rende (CS) (IT); Domenico MUNDO, Cosenza (IT)

(21) Appl. No.: 18/864,268

(22) PCT Filed: May 11, 2023
(86) PCT No.: PCT/IB2023/054881

§ 371 Date: Nov. 8, 2024

(30) Foreign Application Priority Data
May 13, 2022 (IT) 102022000009980

(51) Int. Cl. B29C 64/209; B29C 64/245; B29C 64/321; B33Y 30/00; B33Y 40/10

(52) U.S. Cl. CPC B29C 64/209; B29C 64/245; B29C 64/321; B33Y 30/00; B33Y 40/10

(57) ABSTRACT

Extrusion device comprising first means for feeding reinforcing filaments; second means for feeding molten thermoplastic material; an impregnation chamber for impregnating the reinforcing filaments with the thermoplastic material so as to provide an impregnated multifilament; a device body which defines: (a) first openings for transit of the reinforcing filaments from the first feeding means to the impregnation chamber; (b) at least one second opening for transit of the thermoplastic material from the second feeding means to the impregnation chamber; a nozzle for dispensing the impregnated multifilament; a twisting member arranged, in terms of fluid flow, upstream of and rotatably with respect to the dispensing nozzle so as to produce the vortex movement of the thermoplastic material inside the impregnation chamber and therefore—by means of said vortex—cause twisting of the reinforcing filaments.

The present invention relates to an extrusion device for a 3D printer.

Furthermore, the present invention relates to a device for cutting an impregnated reinforcing monofilament or an impregnated multifilament for a 3D printer.

Furthermore, the present invention relates to a 3D printer comprising said extrusion device and/or said cutting device.

Polymer matrix composite materials are well-known and their use has now become well-established in various sectors owing to the significant structural capacities provided by the reinforcing fibre and the lightness of the polymer materials. The most widespread type consists of thermosetting matrix composites where, by exploiting the minor viscosity during processing of costly high-performance resins, suitably positioned reinforcing fibres are impregnated.

After a complex curing process and with the aid of costly moulds and machinery a final finishing component is obtained. In the case of thermoplastic resins the same considerations apply, but the impregnation of the fibres is made more difficult by the processing of chains which are already polymerized and therefore have a higher processing viscosity.

Solutions based on the 3D moulding of long-fibre composite material have been developed and recently introduced onto the market in order to increase the flexibility of the composite material processing procedures without foregoing the mechanical performance features of the obtainable products. The various additive techniques currently available on the market use pre-impregnated fibres or fibres to be impregnated in situ, but none of the printers allow the impregnation of a thermoplastic matrix fibre which, as mentioned, is characterized by a greater viscosity and therefore gives rise to greater impregnation difficulties.

The Applicant, after a long and in-depth R&D activity, has developed an extrusion device and a 3D printer which is able to provide a suitable response to the existing limitations, drawbacks and problems.

According to a different and separate innovative core according to the present invention, various cutting systems for filaments or fibres impregnated with polymers are known in the art. By way of example U.S. Pat. Nos. 10,814,511B2 and 10,040,240B1.

However, the known cutting systems are constructionally complex (and therefore costly to produce, maintain and/or manage) or are not very precise during the cutting operations.

The Applicant, after a long and in-depth R&D activity, has developed a cutting device and a 3D printer able to provide a suitable response to the existing limitations, drawbacks and problems.

Therefore, the present invention relates to an extrusion device for a 3D printer having the characteristic features as defined in the attached claims.

Furthermore, the present invention relates to a device for cutting an impregnated reinforcing filament or an impregnated multifilament for a 3D printer, having the characteristic features as defined in the attached claims.

Furthermore, the present invention relates to a 3D printer comprising said extrusion device and/or said cutting device, having the characteristic features as defined in the attached claims.

Preferred embodiments of the present invention will be described hereinbelow by way of a non-limiting example with reference to the drawings in which:

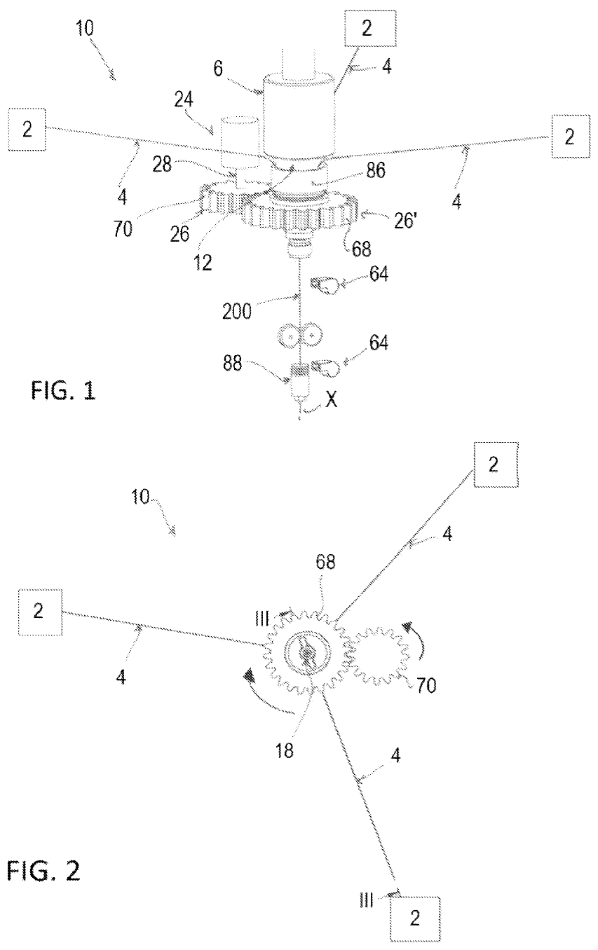

FIG. 1 is a perspective view of an extrusion device, forming the subject of the present invention, according to a possible embodiment;

FIG. 2 is a bottom plan view of the extrusion device according to FIG. 1;

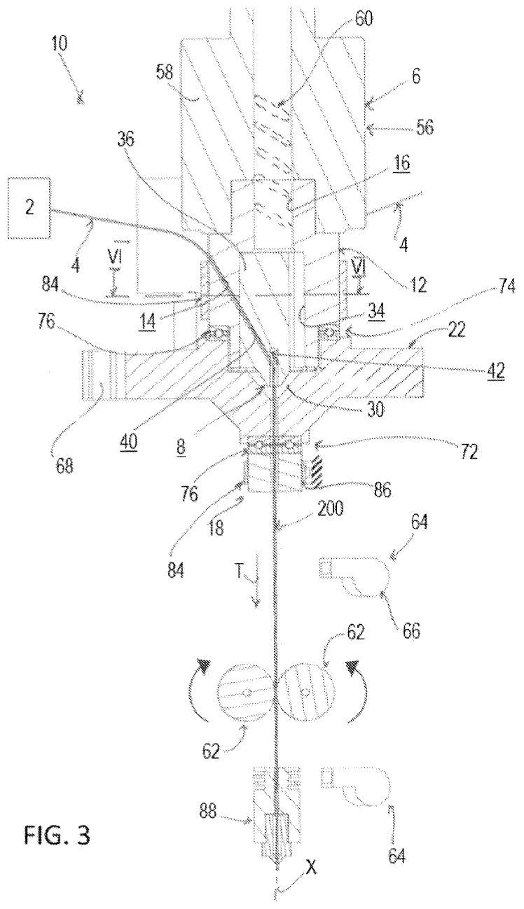

FIG. 3 is a cross-sectional view along the plane III-III shown in FIG. 2;

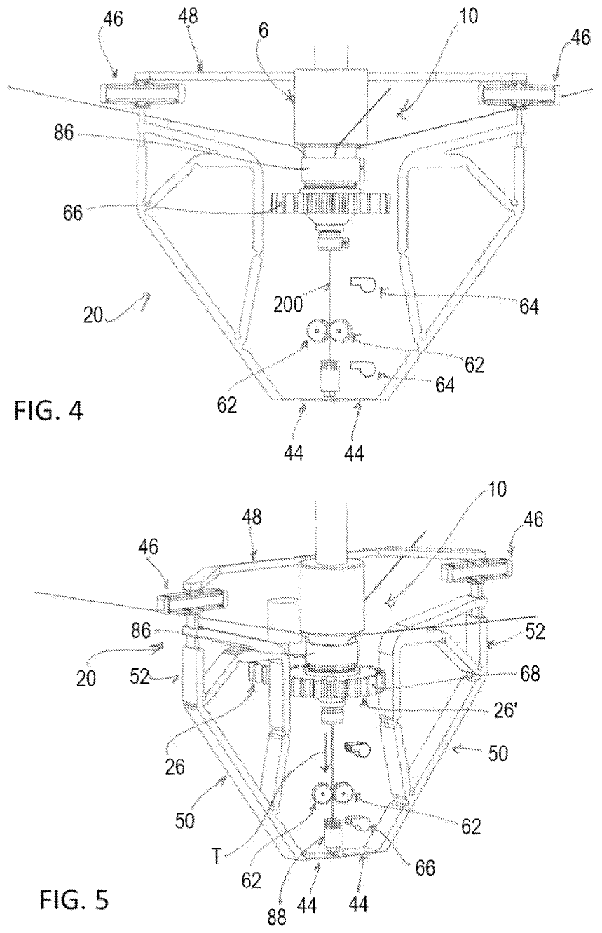

FIGS. 4, 5 are respectively a side view and a perspective view of an extrusion device according to FIG. 1 in association with a cutting device, the latter according to a possible embodiment;

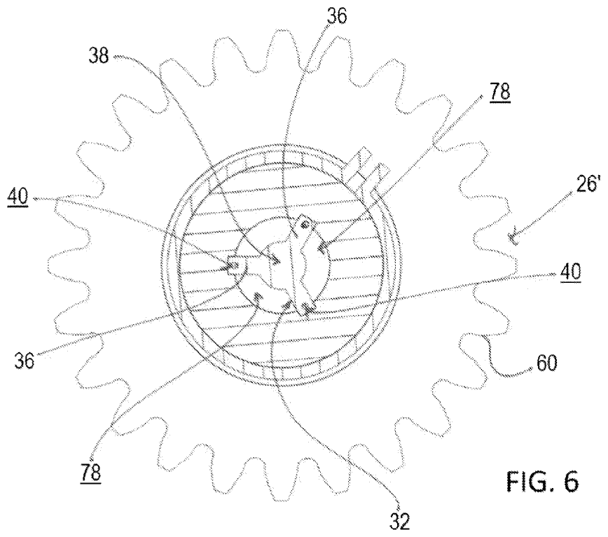

FIG. 6 is a perpendicular cross-section through the device body above the impregnation chamber, along the plane VI-VI shown in FIG. 3, in which the central core and the separation walls are visible;

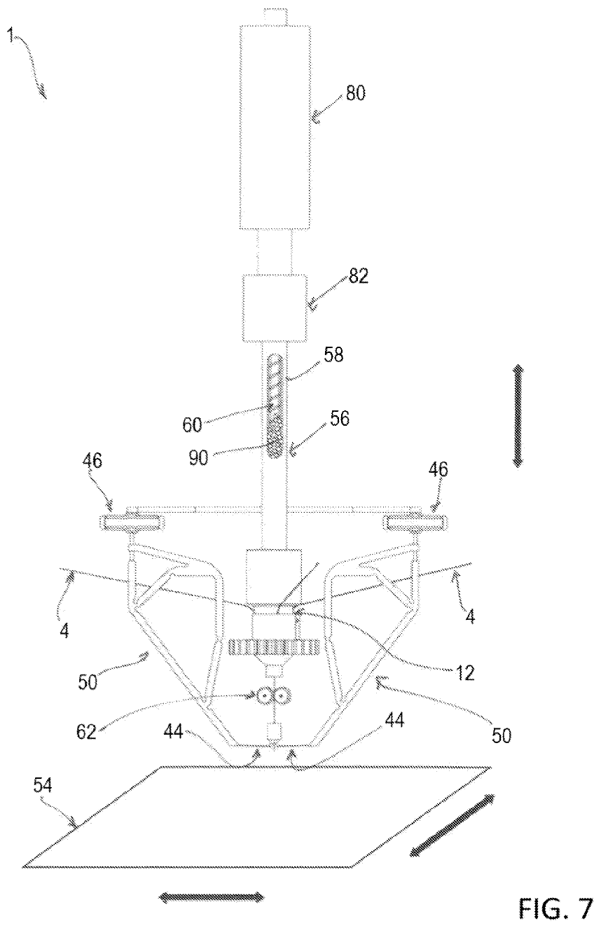

FIG. 7 is a side view of a 3D printer comprising a support surface, an extrusion device and cutting device forming the subject of the present invention, according to possible embodiments, which are movable in space by means of a Cartesian system (schematically indicated by means of three double arrows);

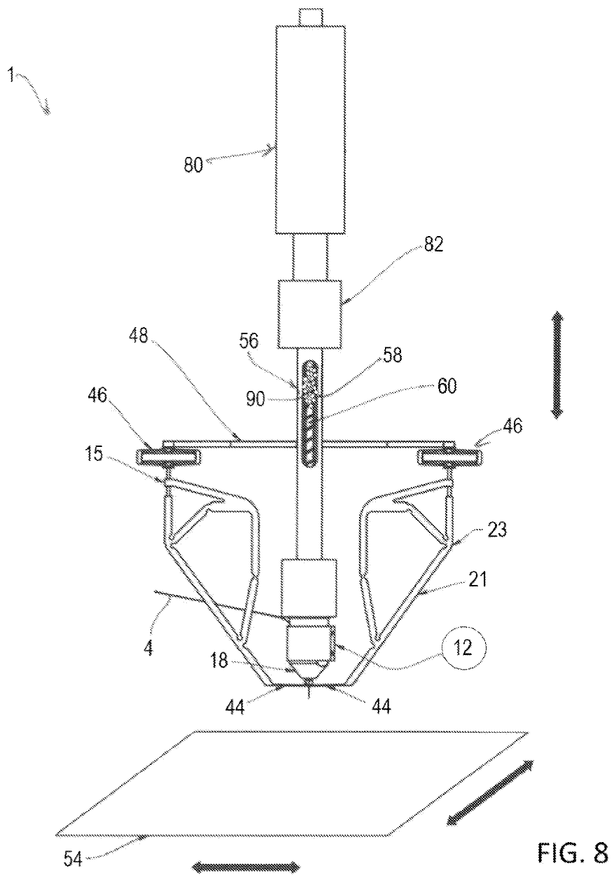

FIG. 8 is a side view of a support surface and a cutting device forming the subject of the present invention, according to a possible embodiment, associated with a conventional extrusion device (for example for the production of an impregnated reinforcing monofilament), which can be moved in space by means of a Cartesian system (schematically indicated by means of three double arrows).

It is pointed out that, in the attached figures, identical or equivalent technical features are indicated by means of the same reference numbers.

The present invention therefore relates to a 3D printer 1 comprising:
(A) an extrusion device 10;
(B) optionally a cutting device 20;
(C) optionally a support surface 54 for a 3D article.

The extrusion device 10 comprises first means 2 for feeding reinforcing filaments 4, second means 6 for feeding a thermoplastic material 90 which is at least partially molten, and at least one impregnation chamber 8 extending around an axis X, preferably a main axis of development X of an impregnated reinforcing monofilament or a multifilament 200.

In the present description the expressions “radial” or “axial” will always be in relation to the X axis unless otherwise specified or implicit from the context.

The reinforcing filaments 4 preferably comprise or consist of glass fibres, carbon fibres, metal filaments, synthetic filaments, synthetic fibre filaments, natural fibre filaments and combinations thereof.

In the embodiment shown in FIG. 2, the extrusion device 10 comprises three feeding means 2 (only schematically shown), where the three reinforcing filaments 4 fed by the first feeding means 2 extend along radial directions which are substantially equidistant (at about 120°) around the axis X. In accordance with other embodiments (not shown), the extrusion device 10 could comprise a number of first feeding means 2 less than or greater than that shown.

Each of the first feeding means 2 comprises preferably at least one reel of filament.

In the present description, the expression “thermoplastic” means a material or substance which has the property of acquiring, in a reversible manner, plasticity—and therefore the capacity to be modelled—under the action of heat.

In the present description the expression “thermoplastic material” means a single thermoplastic material or a mixture of two or more thermoplastic materials of a different kind.

In the present description “at least partially molten” means that the thermoplastic material has become plastic and has become malleable under the action of the heat.

Preferably, the second 6 for feeding the means thermoplastic material 90 comprise at least one endless screw extruder 56, preferably of the type for granules or pellets of thermoplastic material 90. In accordance with the embodiment shown in FIG. 3 and in FIG. 7 or FIG. 8, the endless screw extruder 56 comprises a hollow inside extruder body 58, preferably with a tubular shape, which at least one endless screw 60 (for example a single endless screw 60 or a pair of endless screws having opposite directions of rotation) is rotatably mounted. Optionally said endless screw extruder 56 could comprise first heating means (not shown) which are in thermal contact with the hollow extruder body 58.

With reference to the embodiments shown in FIG. 7 or FIG. 8, the extrusion device 10 comprises at least one drive motor 80 for operating the endless screw 60 and, optionally, at least one reduction gear 82 for the movement of the endless screw 60 which is mechanically arranged between said drive motor 80 and said endless screw 60.

Inside the impregnation chamber 8 the reinforcing filaments 4 are impregnated with the thermoplastic material 90 so as to provide an impregnated multifilament 200.

According to one embodiment, the driving force which causes the reinforcing filaments 4 to pass through the impregnation chamber is the thrust (produced by the endless screw 60) acting on the at least partially molten thermoplastic material 90.

According to another embodiment, for example schematically shown in the figures, the extrusion device 10 could comprise a pair of driving wheels or rollers 62 which operate together so as to drive the impregnated multifilament 200. In this embodiment, the driving force which causes the reinforcing filaments 4 to pass through the impregnation chamber 8 is therefore exerted by the driving rollers (or wheels) 62.

The extrusion device 10 further comprises at least one device body 12, at least one dispensing nozzle 18 and at least one twisting member 22.

The device body 12 defines: first openings 14 for the transit of the reinforcing filaments 4 from the first feeding means 2 to the impregnation chamber 8, and at least one second opening 16 for transit of the thermoplastic material 90 from the second feeding means 6 to the impregnation chamber 8. Preferably, the second transit opening 16 is in fluid communication with the second feeding means 6 and, in particular, with an internal cavity of the hollow extruder body 58.

According to one embodiment, the dispensing device 10 comprises second heating means 84 which are in thermal contact with the device body 12 and/or with the dispensing nozzle 18. Preferably, the second heating means 84 comprise or consist of one or more electric resistances

In accordance with the embodiment, each electric resistance comprises a resistance body 86 which extends in an annular or semi-annular manner around the device body 12 and/or the dispensing nozzle 18 and is mounted coaxially with said device body 12 and/or said dispensing nozzle 18.

The impregnated multifilament 200 exits the extrusion device 10 through the at least one dispensing nozzle 18, preferably a calibrated dispensing nozzle 18.

In accordance with different embodiments, the dispensing nozzle 18 could form a printing nozzle of the 3D printer or could be a nozzle separate from a printing nozzle 88 of the 3D printer 1. For the embodiments in which the dispensing nozzle 18 is separate from the printing nozzle 88 of the 3D printer 1, an extrusion speed of the impregnated multifilament 200 could be adjusted independently of a printing deposition speed through the printing nozzle 88. In particular, the extrusion device 10 could comprise an impregnated multifilament temporary store or buffer 200 (for example realized by means of one or more multifilament loops) between the dispensing nozzle 18 and the printing nozzle 88, so as to allow the formation of said temporary store or buffer.

By way of example, said independent adjustment of the extrusion speed and the printing speed could be obtained by means of management and control means (not shown) which are functionally connected to the drive motor 80 and to a drive for at least one of the driving wheels 62 discussed below.

The extrusion device 10 could optionally comprise means 64 for cooling the impregnated multifilament 200, for example one or more cooling fans 66. Preferably, at least one cooling fan 66 is arranged downstream of the dispensing nozzle 18 with respect to the direction of transit T of the impregnated multifilament 200 and, more preferably, upstream of the drive rollers or wheels 62.

According to the embodiment shown in FIGS. 1 and 3, the extrusion device 10 comprises two cooling means 64 (in particular two cooling fans 66), one being arranged between the dispensing nozzle 18 and the driving rollers or wheels 62 and the other one being arranged downstream of the driving rollers or wheels 62.

The twisting member 22 is arranged, in terms of fluid flow, upstream of and rotatably with respect to the dispensing nozzle 18 so as to produce a vortex movement of the thermoplastic material 90 inside said impregnation chamber 8 and therefore—by means of said vortex—cause twisting of the reinforcing filaments 4.

In other words, the twisting member 22 is mounted rotatably with respect to the dispensing nozzle 18 (where the dispensing nozzle 18 is consequently rotationally fixed with respect to the twisting member 22) and is able to cause a vortex movement of the thermoplastic material 90.

Under the action of the thermoplastic material 90 the reinforcing filaments 4 will be twisted together in a preferred spiral form.

Preferably, the twisting member 22 is mounted rotatably along an axis which is substantially parallel with (more preferably is parallel and coincides with) the axis X.

In accordance with one embodiment, the extrusion device 10 comprises first friction-reducing means 72 which are mechanically arranged between the twisting member 22 and the dispensing nozzle 18.

In accordance with another embodiment, the extrusion device 10 comprises second friction-reducing means 74 which are mechanically arranged between the twisting member 22 and hollow extruder body 58. Preferably, the first friction-reducing means 72 and the second friction-reducing means 74 are selected, independently of each other, from a ring nut or a part made of a fluoropolymer with a low coefficient of friction (for example PTFE) or at least one rolling means 76 (for example a ball or roller bearing).

In accordance with one embodiment (not shown), the twisting member 22 comprises or consists of a rotary mixer inserted inside the impregnation chamber 8.

Preferably, the twisting member 22 delimits a bottom wall 30 (preferably a bottom frustoconical wall) of said impregnation chamber 8. More preferably, the twisting member 22 is formed by a cup-shaped body.

The dispensing nozzle 18 has preferably a transverse throughflow cross-section (or a diameter) and a nozzle length which are calibrated so as to reduce at least partly (preferably so as to stop) the vortical flow of thermoplastic material 90 in the impregnated multifilament 200. In this way, the impregnated multifilament 200 has fewer (or substantially zero) residual internal tension.

By way of example, the transverse throughflow diameter could be comprised from 0.2 mm to 3.0 mm (preferably comprised from 0.5 mm to 2.00 mm) and said nozzle length could be comprised from 5.00 mm to 50 mm (preferably comprised from 10 mm to 35 mm).

In accordance with a preferred embodiment, the extrusion device 10 further comprises motor means 24 for moving the twisting member 22 rotationally.

The motor means 24 preferably comprise a drive shaft 28 connected to the twisting member 22 via transmission means 26, 26′.

In the embodiments shown, the transmission means 26, 26′ comprise one or more gears.

With reference to the embodiment shown in FIG. 3, a first gear 26′ associated with the twisting member 22 is connected to the twisting member 22 and is delimited by first radial outer teeth 68.

With reference to the embodiment shown in FIGS. 1 and 2, a second gear 26 could be keyed onto the drive shaft 28 and be delimited by second radial outer teeth 70 which complement said first radial outer teeth 68.

According to other embodiments (not shown), the transmission means could comprise belt or chain transmission systems.

The drive The shaft 28 can be preferably rotationally controlled (for example by means of the management and control means—not shown—preferably a programmable logic controller or PLC) with an annular speed which is adjustable so as to cause a desired twisting in the reinforcing filaments 4 in said impregnated multifilament 200.

Consequently, a greater (or lesser) angular speed of the drive shaft 28 will correspond to a greater (or lesser) angular speed of the twisting member 22, a greater (or lesser) vertical movement of the thermoplastic material 90, and therefore a greater (or lesser) twisting in the reinforcing filaments 4 of the impregnated multifilament 200.

In accordance with a preferred embodiment, the extrusion device 10 also comprises at least one flow separator 32 for the thermoplastic material 90.

Preferably, the flow separator 32 is arranged, in terms of fluid flow, upstream of the impregnation chamber 8, more preferably between the second opening 16 for transit of the thermoplastic material 90 and the impregnation chamber 8.

In the embodiment shown in FIG. 3, the flow separator 32 is at least partially housed inside a body compartment 34 of the device body 12 and comprises one or more separating walls 36 which extend from a central core 38 (FIG. 6) in a radial direction with respect to the axis X and which delimit(s) a plurality of throughflow cross-sections 78. The separating wall 36 or the plurality of separating walls is therefore intended to separate the single flow entering into the device body 12 into a plurality of partial flows passing through said throughflow cross-sections 78. In these partial flows, the vortical movement components resulting from the second feeding means 6 (for example generated by the endless screw 60) are reduced or substantially zero, and this effect favourably affects the impregnation capacity of the reinforcing fibres 4.

A thickness of each separating wall 36 is preferably crossed by at least one radial duct 40 which receives at least partly a reinforcing filament 4 and which extends from the first transit openings 14 to a recess 42 delimited by the central core 38.

The reinforcing filaments 4 are then guided through the respective radial ducts 40 into a substantially central position of the body compartment 34.

Preferably, the radial ducts 40 converge into the aforementioned said recess 42, in terms of fluid flow, upstream of the impregnation chamber 8 so that the reinforcing filaments 4 are conveyed alongside each other before reaching the impregnation chamber 8 or in any case before impregnation of said filaments has been completed.

The 3D printer 1 preferably also comprises at least one device 20 for cutting the impregnated multifilament 200.

In accordance with a particularly preferred embodiment, the cutting device 20 comprises at least one movable cutter 44 which is operated by at least one piezoelectric actuator 46. Preferably, the movable cutter 44 is arranged at the dispensing nozzle 18 or the printing nozzle 88.

In the present description the expression “piezoelectric” refers to the properties of some crystalline materials to polarize, generating a difference in electric potential when they are subject to mechanical deformations (direct piezoelectric effect) or, on the contrary, to be deformed in an elastic manner when subjected to an electric voltage (so-called “reverse” piezoelectric effect or Lippmann effect). As regards the actuator used in the present cutting device 20, the expression “piezoelectric” is understood as meaning the reverse piezoelectric effect (or Lippmann effect).

According to embodiments, not shown, said piezoelectric actuator 46 could be replaced by a mechanical actuator or an electro-mechanical actuator for operation of the at least one movable cutter 44. In other words, the cutting device 20 could comprise the at last one movable cutter 44 operated by the mechanical or electro-mechanical actuator.

In accordance with an embodiment (not shown), the cutting device 20 comprises a single movable cutter 44 which cooperates with a fixed stop so as to exert a cutting action on the impregnated multifilament 200. Said fixed stop is preferably arranged at the dispensing nozzle 18 or the printing nozzle 88.

Preferably, the cutting device 20 comprises at least one pair of movable cutters 44 (for example: only two movable cutters 44) which operate along mutually opposite cutting directions.

A stroke of the single movable cutter 44 or of the pair of movable cutters 44 is preferably correlated to the transverse throughflow diameter and therefore to the diameter of the impregnated multifilament 200.

Preferably, said piezoelectric actuator 46 is connected at a first end to a support bracket 48 attached to the extrusion device 10 and at a second end, opposite to said first end, to a displaceable rocker member 52 moved by the piezoelectric actuator 46 and connected to the movable cutter 44 by means of a compliant mechanism 50 and, preferably, by means of an articulated pentalateral.

The support surface 54 supports the 3D article formed by means of the superimposition and side-by-side arrangement of impregnated multifilaments 200 exiting the aforementioned extrusion device 10.

Preferably, the extrusion device 10 and the support surface 54 are movable relative to each other in space by means of a Cartesian system (for example see FIG. 7) or by means of a robotic arm with more degrees of freedom.

Advantageously, with the extrusion device according to the present invention it is possible to obtain an impregnated multifilament with limited (or substantially zero) residual internal tension and therefore produce three-dimensional (3D) articles which are superior in terms of quality to the articles which can be obtained with the systems of the prior art. In this connection, the presence of a dispensing nozzle which is non-rotating relative to the twisting member helps maintain the form of the impregnated multifilament following deposition thereof in the printing process.

Advantageously, the cutting device according to the present invention is constructionally simple, extremely precise during the cutting operations and uses very little energy for operation thereof.

Embodiments E(n) according to the present invention are described below:

E1. A 3D printer 1 comprising:
(A) optionally an extrusion device;
(B) a device 20 for cutting an impregnated reinforcing monofilament 4 or an impregnated multifilament 200;
(C) optionally a support surface 54 for a 3D article;
wherein said cutting device 20 comprises at least one movable cutter 44 operated by at least one piezoelectric actuator 46, by a mechanical actuator or by an electro-mechanical actuator.

E2. The 3D printer according to E1, wherein said cutting device 20 comprises a pair of movable cutters 44 which operate along opposite cutting directions

E3. The 3D printer according to either E1 or E2, wherein said piezoelectric actuator 46 is connected at a first end to a support bracket 48 attached to an extrusion device and at a second end, opposite to said first end, to a displaceable rocker member 52 moved by the piezoelectric actuator 46 and connected to the movable cutter 44 by means of a compliant mechanism 50 and, preferably, by means of an articulated pentalateral.

E4. The 3D printer according to E3, wherein the extrusion device has the characteristic features of claim 1.

E5. The 3D printer according to E3, wherein the extrusion device comprises:
a chamber for impregnating a reinforcing filament 4 with a thermoplastic material 90 so as to provide an impregnated reinforcing monofilament, said impregnation chamber 8 extending around an axis X;
at least one device body which defines: (a) a first opening for transit of the reinforcing filament 4 from the first feeding means 2 to the impregnation chamber 8; (b) at least one second opening for transit of the thermoplastic material 90 of second feeding means 6 to the impregnation chamber 8;
at least one dispensing nozzle 18 for dispensing the impregnated reinforcing monofilament.

Further embodiments E(n) according to the present invention are described below:

F1. A 3D printer 1 comprising:
(A) an extrusion device 10 comprising:
first means 2 for feeding the reinforcing filaments 4;
second means 6 for feeding an at least partially molten thermoplastic material 90;
at least one impregnation chamber 8 for impregnating the reinforcing filaments 4 with said thermoplastic material 90 so as to produce an impregnated multifilament 200, said impregnation chamber 8 extending around an axis X;
at least one device body 1 which defines: (a) first openings 14 for transit of the reinforcing filaments 4 from the first feeding means 2 to the impregnation chamber 8; (b) at least one second opening 16 for transit of the thermoplastic material 90 from the second feeding means 6 to the impregnation chamber 8;
at least one dispensing nozzle 18 for dispensing the impregnated multifilament 200;
at least one twisting member 22 arranged, in terms of fluid flow, upstream of and rotatably with respect to the dispensing nozzle 18 so as to produce a vortex movement of the thermoplastic material 90 inside said impregnation chamber 8 and therefore—by means of said vortex—cause twisting of the reinforcing filaments 4.

F2. The 3D printer according to F1, wherein the dispensing nozzle 18—which is rotationally fixed with respect to the twisting member 22—has a throughflow cross-section and a nozzle length which are calibrated so as to reduce at least partly (preferably so as to stop) the vortex-like flow of thermoplastic material 90 in the impregnated multifilament 200.

F3. The 3D printer 1 according to either F1 or F2, wherein the extrusion device 10 further comprises drive means 24 comprising a driving shaft 28 connected to the twisting member 22 via transmission means 26, 26′, said drive shaft 28 being able to be rotationally operated with an adjustable angular speed so as to cause the desired twisting in the reinforcing elements 4 of said impregnated multifilament 200.

F4. The 3D printer 1 according to any one of F1-F3, wherein said twisting member 22 delimits a bottom wall 30 of said impregnation chamber 8, said twisting member 22 being made from a cup-shaped body.

F5. The 3D printer 1 according to any one of F1-F4, wherein said extrusion device 10 further comprises a flow separator 32 for said thermoplastic material 90, said flow separator 32 being at least partially housed inside a body compartment 34 of the device body 12 and comprising one or more separating walls 36 which extend from a central core 38 in the radial direction with respect to the axis X.

F6. The 3D printer 1 according to F5, wherein a thickness of each separating wall 36 is crossed by at least one radial duct 40 which receives at least partly a reinforcing filament 4 and which extends from the first transit openings 14 to a recess 42 delimited by the central core 38.

F7. The 3D printer 1 according to F6, wherein said radial ducts 40 converge inside said recess 42, in terms of fluid flow, upstream of the impregnation chamber 8 so that the reinforcing filaments 4 are conveyed into side-by-side arrangement before reaching the impregnation chamber.

F8. The 3D printer 1 according to any one of F1-F7, further comprising a cutting device 20 for cutting the impregnated multifilament 200, wherein said cutting device 20 comprises at least one movable cutter 44 operated by at least one piezoelectric actuator 46, preferably a pair of movable cutters 44 which operate along opposite cutting directions.

F9. The 3D printer 1 according to F8, wherein said piezoelectric actuator 46 is connected at a first end to a support bracket 48 attached to the extrusion device 10 and, at a second end, opposite to said first end, to a displaceable rocker member 52 moved by the piezoelectric actuator 46 and connected to the movable cutter 44 by means of a compliant mechanism 50 and, preferably, by means of an articulated pentalateral.

F10. The 3D printer 1 according to any one of F1-F9, further comprising a support surface 54 for a 3D article, said 3D article being made by means of superimposition and side-by-side arrangement of impregnated multifilaments 200 exiting the extrusion device 10 according to any one of F1-F7; wherein said extrusion device 10 and said support surface 54 are movable relative to each other in space by means of a Cartesian system or by means of a robotic arm with more degrees of freedom.

With regard to the embodiments of the aforementioned 3D printer, extrusion device and cutting device, a person skilled in the art replace could or modify the characteristic features described, according to needs. These embodiments are also to be regarded as being included within the scope of protection formally defined in the claims below.

Moreover, it is pointed out that any embodiment may be implemented independently of the other embodiments described.

### LIST OF REFERENCE NUMBERS

1 3D printer
2 first feeding means
4 reinforcing filament
6 second feeding means
8 impregnation chamber
10 extrusion device
12 device body
14 first transit openings
16 second transit opening
18 dispensing nozzle
20 cutting device
22 twisting member
24 drive means
26, 26′ transmission means, preferably gears, in particular: first gear 26′, second gear 26
28 driving shaft;
30 bottom wall, preferably frustoconical bottom wall
32 flow separator
34 body compartment
36 separating wall
38 central core
40 radial duct
42 recess
44 movable cutter
46 piezoelectric actuator
48 support bracket
50 compliant mechanism, preferably an articulated pentalateral
52 displaceable rocker member
54 support surface
56 endless screw extruder
58 hollow, preferably tubular shaped, extruder body
60 endless screw
62 driving roller or wheel
64 cooling means
66 cooling fan
68 first radial outer teeth
70 second radial outer teeth
72 first friction-reducing means
74 second friction-reducing means
76 rolling means, for example ball or roller bearings
78 throughflow cross-section
80 endless screw drive motor
82 endless screw movement reduction gear
84 second heating means
86 resistance body
88 printing nozzle
90 thermoplastic material
200 impregnated multifilament
T transit direction
X axis, preferably main axis of extension of an impregnated multifilament (in short multifilament axis) or impregnated reinforcing monofilament.

1-10. (canceled)

11. A three-dimensional (“3D”) printer, comprising:
an extrusion device including:
first means for feeding reinforcing filaments;
second means for feeding an at least partially molten thermoplastic material;
at least one impregnation chamber for impregnating reinforcing filaments with said thermoplastic material so as to provide an impregnated multifilament, said impregnation chamber extending around an axis;
at least one device body that defines: (a) first openings for transit of the reinforcing filaments from the first feeding means to the impregnation chamber; and (b) at least one second opening for transit of the thermoplastic material from the second feeding means to the impregnation chamber;
at least one dispensing nozzle for dispensing the impregnated multifilament; and
at least one twisting member arranged fluidically upstream of and rotatably with respect to the dispensing nozzle so as to produce a vortex movement of the thermoplastic material inside said impregnation chamber and, therefore, said vortex cause twisting of the reinforcing filaments.

12. The 3D printer according to claim 11, wherein the dispensing nozzle, which is rotationally fixed with respect to the twisting member, has a throughflow cross-section and a nozzle length which are calibrated so as to reduce at least partly the vortical flow of thermoplastic material in the impregnated multifilament, wherein a transverse throughflow diameter of the dispensing nozzle is from 0.2 mm to 3.0 mm and said nozzle length is from 5.0 mm to 50 mm.

13. The 3D printer according to claim 11, wherein the extrusion device further includes:
drive means including a driving shaft connected to the twisting member via transmission means, said driving shaft being capable of being rotationally operated with an adjustable angular speed so as to produce a desired twist in the reinforcing elements of said impregnated multifilament.

14. The 3D printer according to claim 11, wherein said twisting member delimits a bottom wall of said impregnation chamber, said twisting member being formed by a cup-shaped body.

15. The 3D printer according to claim 11, wherein said extrusion device further includes:
a flow separator of said thermoplastic material, said flow separator being at least partially housed inside a body compartment of the device body and including one or more separating walls which extend from a central core in a radial direction with respect to the axis.

16. The 3D printer according to claim 15, wherein a thickness of each of the one or more separating walls is crossed by at least one radial duct that receives at least partly a reinforcing filament and that extends from the first transit openings to a recess delimited by the central core.

17. The 3D printer according to claim 16, wherein said radial ducts converge inside said recess fluidically upstream of the impregnation chamber so that the reinforcing filaments are arranged alongside each other before reaching the impregnation chamber.

18. The 3D printer according to claim 11, further comprising:
a device for cutting the impregnated multifilament, wherein said cutting device comprises at least one movable cutter operated by at least one piezoelectric actuator, the at least one movable cutter including a pair of movable cutters that operate along opposite cutting directions.

19. The 3D printer according to claim 11, wherein said piezoelectric actuator is connected at a first end to a support bracket attached to the extrusion device and at a second end, opposite to said first end, to a displaceable rocker member moved by the piezoelectric actuator and connected to the movable cutter by means of a compliant mechanism including an articulated pentalateral.

20. The 3D printer according to claim 11, further comprising:
a support surface for a 3D article, said 3D article being made by means of superimposition and side-by-side arrangement of impregnated multifilaments exiting the extrusion device according to claim 11;
wherein said extrusion device and said support surface are movable relative to each other in space by means of a Cartesian system or by means of a robotic arm with more degrees of freedom.
